(19) United States
(12) Patent Application Publication
(10) Pub. No.: US 2009/0296281 A1
(43) Pub. Date: Dec. 3, 2009

(54) Bearing Assembly Having a Flex Pivot to Limit Gimbal Bearing Friction for Use in a Gimbal Servo System

(75) Inventor: Edward Bruce Baker, Longwood, FL (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: DRS SENSORS & TARGETING SYSTEMS, INC., Dallas, TX (US)

(21) Appl. No.: 11/938,104

(22) Filed: Nov. 9, 2007

Related U.S. Application Data
(60) Provisional application No. 60/865,423, filed on Nov. 11, 2006.
(60) Provisional application No. 60/865,295, filed on Nov. 10, 2006.
(60) Provisional application No. 60/865,321, filed on Nov. 10, 2006.

(51) Int. Cl. G11B 5/48

(52) U.S. Cl. 360/245.3; G9B/5.147

(57) ABSTRACT

A bearing assembly suitable for use in a gimbal servo system is provided. The bearing assembly comprises a housing, a first shaft, a bearing rotatingly coupling the first shaft to the housing such that the first shaft is adapted to rotate about an axis relative to the housing, a second shaft having a first end adapted to be coupled to a payload, and a flex pivot element pivotally coupling an end of the first shaft to a second end of the second shaft such that the second shaft is adapted to rotate relative to the first shaft via the flex pivot element. In response to a rotation of the second shaft, the flex pivot element is adapted to pivot an angle about the first shaft axis. The pivot angle reflects a displacement of the second shaft relative to the first shaft and corresponds to a friction disturbance of the bearing.

### CROSS-REFERENCE TO RELATED APPLICATIONS

This application claims the benefit of the filing date of U.S. Provisional Application No. 60/865,321, entitled “Frictionless Bearing For Use In Servo Systems,” filed on Nov. 10, 2006; U.S. Provisional Application No. 60/865,295, entitled “Frictionless Bearing,” filed on Nov. 10, 2006; and U.S. Provisional Application No. 60/865,423, entitled “Simple Frictionless Bearing,” filed on Nov. 11, 2006, all of which are incorporated herein by reference to extent permitted by law.

### BACKGROUND OF THE INVENTION

The present invention relates to gimbal servo systems used to stabilize one or more axis of a gimballed platform. More particularly, the present invention relates to a bearing assembly for use in a gimbal servo system, where friction associated with a gimbal bearing of the bearing assembly is effectively suppressed.

Gimbal servomechanisms or servo systems are typically used to stabilize gimballed platforms for optical systems (“gimballed optical systems”), such as TV cameras and infrared (IR) cameras on aircraft and ground vehicles, in order to minimize the movement of the line of sight (LOS) of the respective optical system. Conventional gimbal servomechanisms typically employ a rate sensor (such as a gyroscope) mounted on the gimballed platform to sense movement (e.g., angular velocity) about one or more gimballed axis of the platform. A servo or torquer motor of the gimbal servomechanism is used to counter rotate the platform about the respective gimballed axis to compensate for the sensed movement and stabilize the gimballed platform and, thus, the line of sight (LOS) of the optical system mounted on the gimballed platform. However, conventional gimbal bearing assemblies used in gimballed optical systems typically impart a gimbal bearing friction disturbance when the mounting base of the gimballed platform moves about the gimbal axis containing the gimbal bearing. The gimbal bearing friction causes a torque disturbance into the conventional servomechanism or servo system which, in response, produces a jitter or unwanted movement of the LOS of the optical system that may adversely affect the resolution of the gimballed optical system.

Certain conventional gimbal servomechanisms have employed various designs to correct for gimbal bearing friction disturbances to stabilize the line of sight (LOS) of the optical systems to an acceptable LOS stabilization error level. However, the level of the LOS stabilization error for gimballed optical systems is still problematic, especially for optical systems that employ a long focal length camera to, for example, identify and track targets.

In addition, certain conventional servo stabilized gimballed platforms (such as disclosed in Bowditch et al., U.S. Pat. No. 4,395,922) attempt to eliminate gimbal bearing friction by adding more gimbals and using flex pivots with the additional gimbals. Such a solution to the problem of gimbal bearing friction disturbances adds unnecessary complexity and cost to the gimballed system.

FIG. 1 depicts, in cross-sectional view, a conventional bearing assembly and gimbal servo system 10 for stabilizing a single axis 12 (e.g., azimuth axis) of a gimballed platform or payload 14. FIG. 2 is a functional block diagram of the conventional gimbal servo system 30 in FIG. 1. As shown in FIG. 1, the conventional bearing assembly includes a single bearing 16 and seal 18 arrangement. The single bearing 16 rotatingly couples a gimbal axle or shaft 20 attached to the payload 14 along the axis 12 to a housing or support structure 22 so that a servo or torquer motor 23 (a component of the gimbal servo system depicted in functional form in FIG. 2) may rotate the payload 14 to counter movement of the payload about the axis 12 that is sensed by a rate sensor 24 mounted on the payload 14 to sense the angular rate or velocity about the axis 12. The torquer motor 23 is typically implemented via a rotor 26 affixed to shaft 20 and a stator 28 affixed to the support structure 22.

Two additional bearing assemblies and gimbal servo systems 10 (not shown in FIG. 1) are usually employed to stabilize each gimbal axis (e.g., pitch axis and roll axis) of a gimballed platform or payload. Thus, a conventional gimballed platform or payload having three axis of movement typically has a single bearing 16 for each of the three axis.

The bearing 16 typically imparts a friction disturbance in the direction of movement of the payload 14 about the axis 12 of the gimbal shaft 20. The friction disturbance abruptly changes sign (or direction or polarity) when the relative velocity between the shaft 20 and the housing or support structure 22 (e.g., corresponding to payload 14 velocity about the axis 12) changes sign (or direction or polarity). The friction torque change (corresponding to change in sign of the friction disturbance) typically occurs so abruptly that the gimbal servomechanism or system cannot compensate for it quickly enough. As a result, the gimbal or shaft 20 moves before the servomechanism can stop it due to the limited bandwidth and finite response time of the servomechanism, which results in jitter movement about the axis 12. Since the gimbal bearing friction disturbance is usually non-linear and not entirely predictable, conventional gimbal servomechanisms or systems fail to accurately compensate for the friction.

The conventional gimbal servo system 30 for each gimbal axis typically includes a servo controller (not shown in FIG. 1) that includes a summer 32 that is operatively configured to output a velocity difference between a rate command signal 34 (usually supplied by a vehicle system controller not shown in the figures) and the angular velocity sensed by the rate sensor 24. The servo controller also typically includes a compensator 36 operatively configured to receive the velocity difference output from the summer 32 and output a compensation rate signal that is adjusted by a rate loop gain controller and then amplified by a power amplifier 40. The amplified compensation rate signal 42 output from the power amplifier is received by the torquer motor 23, which supplies a counter rotation torque 44 that is adjusted (as modeled by the summer 46) by friction disturbance 48 of the bearing 16 (which has a sign corresponding to the direction of movement of the payload 14 about the shaft 20). The adjusted counter rotation torque 50 when applied to the gimbal shaft 20 is effectively multiplied by the reciprocal of the known gimbal inertia (1/J_{G}) corresponding to the gimbal shaft 20 (as modeled by the multiplier 52). The resulting gimbal 20 acceleration 54 is effectively integrated (as modeled by the integrator 56) to produce the angular velocity 58 of the platform 14 that is sensed by the rate sensor 24 and induces the friction disturbance 48 of the bearing 16 in the same direction as the angular velocity 58.

As shown in FIG. 2, the compensator 32 is typically a proportional plus integral (PI) compensator with a break frequency (ω_{z}) set to maximize the low frequency gain of the gimbal servo system 30 while still maintaining a sufficient phase margin at the zero dB crossover frequency of the counter rotation torque 44 output of the torquer motor 23. The zero dB crossover frequency is typically between 25 and 60 Hz. The compensator 32 typically has an infinite static gain due to the integrator 56. However, due to the limited gain of the servo system 30 at the frequencies of the friction disturbance 48 torque, the payload 14 (and the LOS of the optical system comprising the payload) jitters as a result of the friction disturbance 48. Increasing the zero dB crossover frequency of the servo system 30 and thereby increasing the open loop gain of the servo system 30 may reduce the effect of the friction disturbance 48. However, due to limitations in the servo system 30, such as limited bandwidth of the rate sensor 24 or structural resonances, it is usually not possible to reduce the effects of the bearing friction disturbance 48 to a sufficiently low level.

FIGS. 3A-3D show the effect of angular motion of the support structure 22 inducing the friction disturbance 48 of the bearing 16 and causing jitter of the gimballed platform or payload line of sight (LOS). FIG. 3A is an exemplary graph depicting the angular position of the support structure 22 of the conventional bearing assembly shown in FIG. 1 relative to the gimbal (i.e., shaft 20) over time. FIG. 3B is an exemplary graph of the angular velocity of the support structure 22 relative to the gimbal 20 over time, where the angular velocity corresponds to the angular position shown in FIG. 3A. FIG. 3C is an exemplary graph of the friction torque of the bearing 16 coupling the support structure 22 to the gimbal 20 of the conventional bearing assembly, where the bearing friction torque is generated based on the angular velocity of the support structure shown in FIG. 3B. FIG. 3D is an exemplary graph of the LOS jitter of the gimballed platform or payload 14 caused by the bearing 16 friction torque shown in FIG. 3C. For a typical two axis gimbal with bearings 16 and seals 18 and a 40-50 Hz zero dB crossover frequency on the servo system 30, the LOS jitter (as reflected in FIG. 3D) due to bearing friction disturbance 48 is 200-300 micro radians peak to peak. Thus, bearing friction disturbances remain problematic for gimballed optical systems in which image resolution is impacted by a LOS jitter of 200-300 micro radians peak to peak.

There is therefore a need for a bearing assembly that overcomes the problems noted above and enables the realization of gimbal servo system in which a bearing friction disturbance is effectively negated to avoid jitter of the gimballed platform or payload.

### SUMMARY OF THE INVENTION

Systems, apparatuses, and articles of manufacture consistent with the present invention provide a means for use in a gimbal servo system to compensate for or eliminate a friction disturbance imparted on a gimbal by a bearing (“bearing friction”) to effectively prevent jitter of the gimballed platform or payload stabilized by the gimbal servo system.

In accordance with systems and apparatuses consistent with the present invention, a bearing assembly suitable for use in a gimbal servo system is provided. The bearing assembly comprises a housing, a first shaft having an end and an axis, and a bearing that rotatingly couples the first shaft to the housing such that the first shaft is adapted to rotate about the axis relative to the housing. The bearing assembly further comprises a second shaft and a flex pivot element. The second shaft has a first end and a second end. The first end of the second shaft is adapted to be coupled to a payload. The flex pivot element pivotally couples the end of the first shaft to the second end of the second shaft such that the second shaft is adapted to rotate relative to the first shaft via the flex pivot element. In response to a rotation of the second shaft, the flex pivot element is adapted to pivot an angle about the first shaft axis, the pivot angle reflecting a displacement of the second shaft relative to the first shaft.

In one implementation, the pivot angle corresponds to a friction disturbance imparted by the bearing on the first shaft due to the rotation of the second shaft relative to the housing.

The bearing assembly may include a first motor operatively configured to rotate the second shaft relative to the housing. The bearing assembly may also include a position transducer disposed in proximity to the flex pivot element. The position transducer is adapted to sense the pivot angle and output a corresponding displacement signal. The first motor may be operatively coupled to the displacement signal and adapted to torque the second shaft in accordance with the displacement signal.

In another implementation, the bearing assembly may also include a bearing motor operatively coupled to the displacement signal output by the position transducer and operatively configured to rotate the first shaft relative to the housing to compensate for the torque reflected by the displacement signal.

Other systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1 shows a cross-sectional view of a conventional bearing assembly and servo system for stabilizing a single axis of a gimballed platform or payload;

FIG. 2 is a functional block diagram of the gimbal servo system in FIG. 1;

FIG. 3A is a graph of the angular position of a support structure of the conventional bearing assembly in FIG. 1 relative to the single axis gimbal versus time;

FIG. 3B is a graph of the angular velocity of the support structure of the conventional bearing assembly relative to the single axis gimbal versus time, where the angular velocity corresponds to the angular position shown in FIG. 3A;

FIG. 3C is a graph of the friction torque of a bearing coupling the support structure to the gimbal of the conventional bearing assembly, where the bearing friction torque is generated based on the angular velocity shown in FIG. 3B of the support structure;

FIG. 3D is a graph of the gimballed platform or payload LOS jitter caused by the bearing friction torque shown in FIG. 3C;

FIG. 4 shows a cross-sectional perspective view of a bearing assembly consistent with the present invention;

FIG. 5 is a functional block diagram of an exemplary gimbal servo system for a gimbal implemented in accordance with the present invention, using the bearing assembly depicted in FIG. 4;

FIG. 6A is an exemplary time history graph of the angular position or rotation of an inner or second payload support shaft (“inner shaft”) of the bearing assembly in FIG. 4;

FIG. 6B is an exemplary time history graph of a pivot angle or displacement of a flex pivot element of the bearing assembly based on the angular position or rotation of the inner shaft shown in FIG. 6A, where the flex pivot element couples the inner shaft to an outer or first payload support shaft (“outer shaft”) of the bearing assembly in FIG. 4 and the pivot angle or displacement reflects a displacement of the inner shaft relative to the outer shaft;

FIG. 6C is an exemplary time history graph of the torque of the flex pivot element on the outer shaft based on the angular position or rotation of the inner shaft shown in FIG. 6A, where the flex pivot element torque corresponds to a friction disturbance imparted on the outer shaft by a bearing that couples the outer shaft to a housing of the bearing assembly of FIG. 4;

FIG. 6D is an exemplary time history of the displacement of an inner race member relative to an outer race member of the bearing shown in FIG. 4 that couples the outer shaft to the housing, where the inner race member is attached to the outer shaft and the outer race member is attached to the housing;

FIG. 6E is an exemplary time history graph of the flex pivot compensation torque output by a torquer motor of the bearing assembly of FIG. 4 to torque the inner shaft to counter the torque of the flex pivot element shown in FIG. 6C;

FIG. 6F is an exemplary time history graph of the friction disturbance or torque of the bearing shown in FIG. 4 imparted on the outer shaft;

FIG. 7 shows a cross-sectional perspective view of another bearing assembly consistent with the present invention;

FIG. 8 is a functional block diagram of an exemplary gimbal servo system for a gimbal implemented in accordance with the present invention, using the bearing assembly depicted in FIG. 7;

FIG. 9A is an exemplary time history graph of a sinusoidal position change (i.e., angular position) of the housing or support structure of the bearing assembly in FIG. 7 relative to a gimbal axis of the outer shaft, where the gimbal (i.e., the outer shaft) is stabilized or stationary;

FIG. 9B is a time history graph of the angular velocity of the housing or support structure of the bearing assembly in FIG. 7 relative to the gimbal axis and the outer shaft;

FIG. 9C is a time history graph of the friction disturbance or torque of a bearing of the bearing assembly of FIG. 7 that rotatingly couples the outer shaft to the housing, where the bearing friction torque is imparted on the outer shaft in response to the angular velocity or torque of the bearing assembly housing relative to the outer shaft;

FIG. 9D is an exemplary time history graph of a pivot angle or displacement of a flex pivot element (“flex pivot displacement”) of the bearing assembly of FIG. 7 based on the rotation of the inner shaft due to the angular velocity or rotation of the housing as shown in FIG. 9B, where the flex pivot element couples the inner shaft to the outer shaft of the bearing assembly and the flex pivot displacement reflects a displacement of the inner shaft relative to the outer shaft;

FIG. 9E is an exemplary time history graph of the torque of the flex pivot element on the outer shaft based on the flex pivot displacement shown in FIG. 9D;

FIG. 9F is an exemplary time history graph of the flex pivot compensation torque output by a torquer motor of the bearing assembly of FIG. 7 to torque the inner shaft to counter the torque of the flex pivot element shown in FIG. 9E;

FIG. 9G is an exemplary time history of the angular velocity of an outer race member relative to an inner race member of the bearing in FIG. 7 that couples the outer shaft to the housing, where the inner race member is attached to the outer shaft and the outer race member is attached to the housing;

FIG. 9H is an exemplary time history graph of the displacement of the outer race member relative to the inner race member of the bearing shown in FIG. 7 in response to the angular position change as shown in FIG. 9A of the inner shaft relative to the housing;

FIG. 10A is an exemplary time history graph of a ramp position change (i.e., angular position) of the inner shaft relative to the housing of the bearing assembly in FIG. 7;

FIG. 10B is an exemplary time history graph of the pivot angle or displacement (“flex pivot displacement”) of the flex pivot element of the bearing assembly in FIG. 7 based on the angular position or rotation of the inner shaft shown in FIG. 10A;

FIG. 10C is an exemplary time history of the displacement of the inner race member relative to the outer race member of the bearing shown in FIG. 7 that couples the outer shaft to the housing;

FIG. 10D is an exemplary time history graph of the torque of the flex pivot element on the outer shaft based on the flex pivot displacement shown in FIG. 10B;

FIG. 10E is an exemplary time history graph of the flex pivot compensation torque output by a torquer motor of the bearing assembly of FIG. 7 to torque the inner shaft to counter the torque of the flex pivot element shown in FIG. 10D;

FIG. 10F is an exemplary time history graph of the friction disturbance or torque of the bearing shown in FIG. 7 imparted on the outer shaft in response to the angular position change as shown in FIG. 10A of the inner shaft relative to the housing; and

FIG. 10G is an exemplary time history graph of the bearing compensation torque output by a bearing motor of the bearing assembly of FIG. 7 to torque the outer shaft to counter the bearing friction disturbance or torque shown in FIG. 10F.

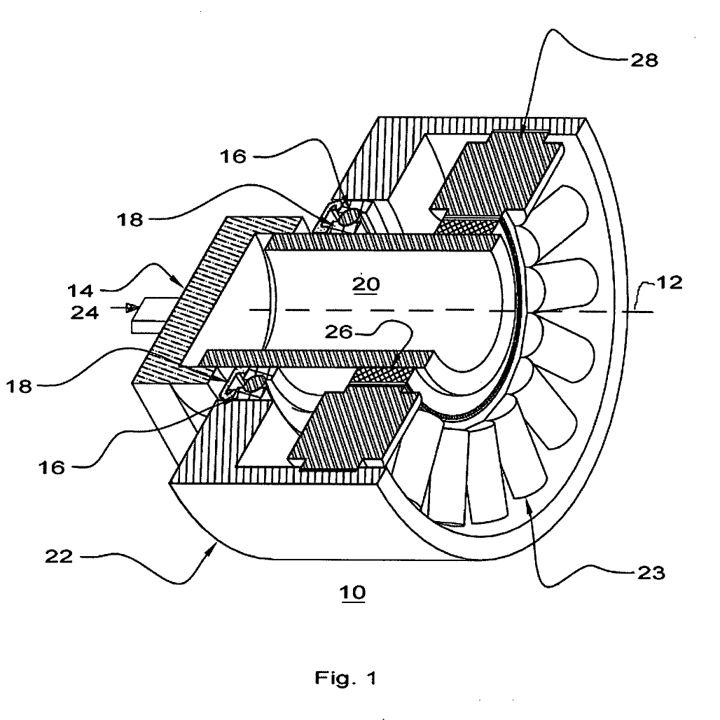

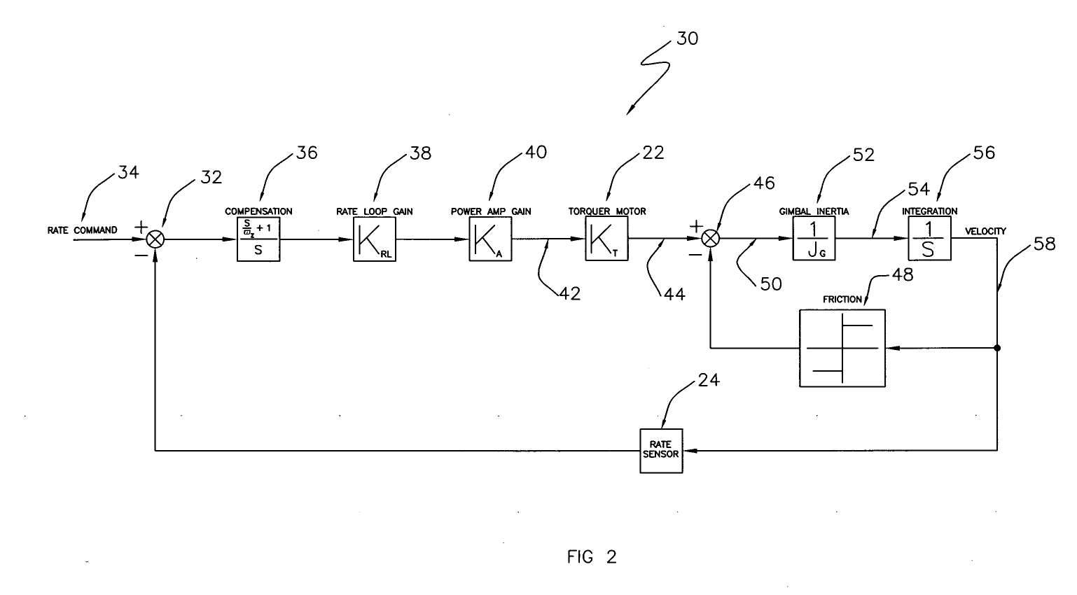

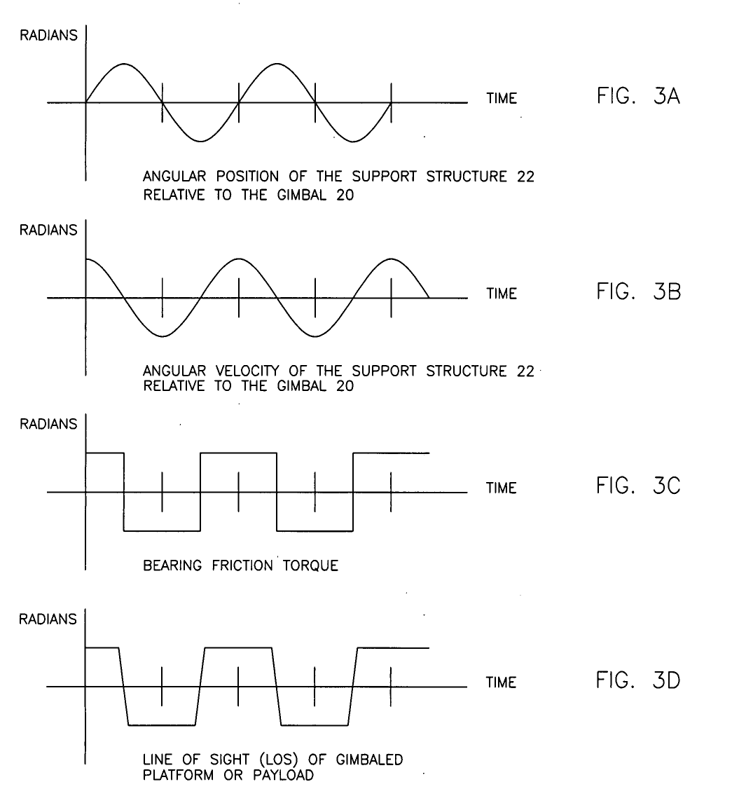

### DETAILED DESCRIPTION OF THE INVENTION

Reference will now be made in detail to an implementation in accordance with methods, systems, and products consistent with the present invention as illustrated in the accompanying drawings.

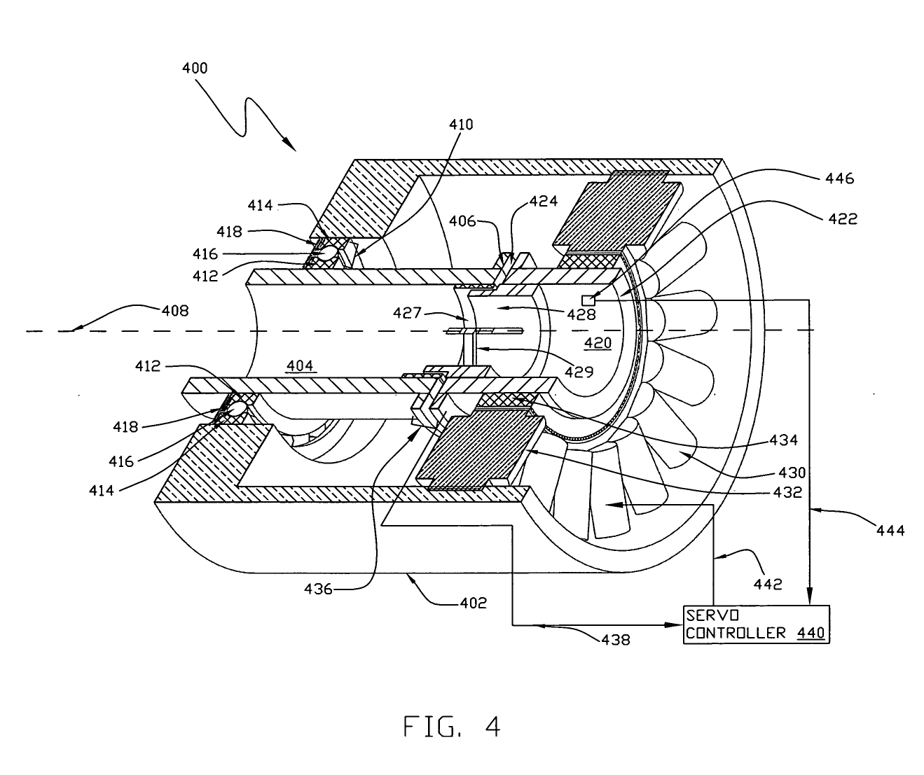

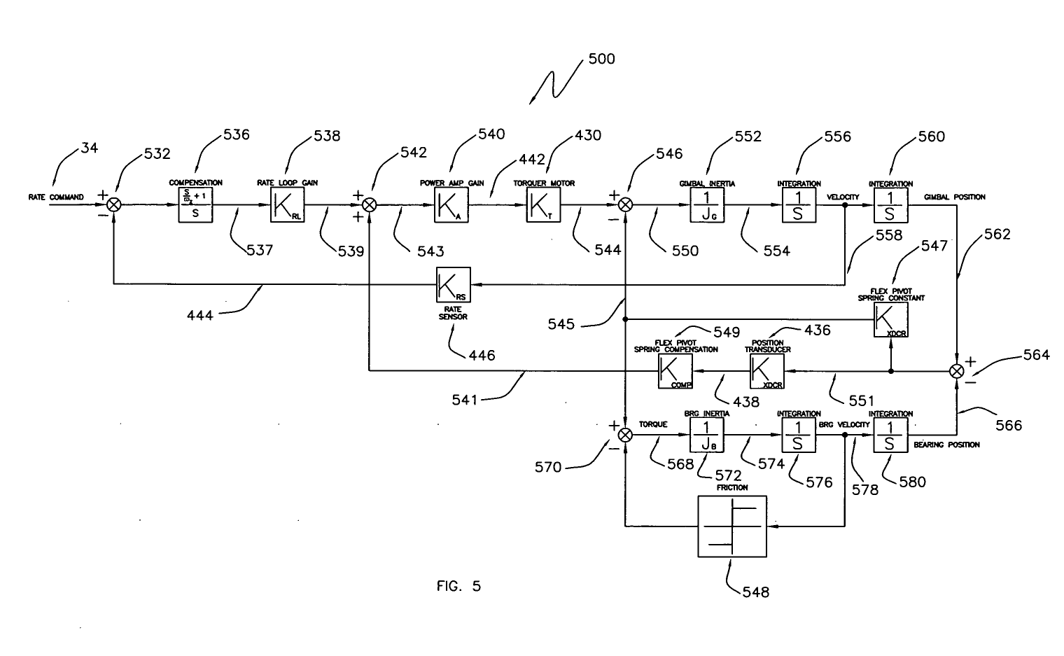

FIG. 4 shows a cross-sectional perspective view of a bearing assembly 400 consistent with the present invention. The bearing assembly 400 may be used in a gimbal servo system (such as the gimbal servo system 500 depicted in FIG. 5) to stabilize a gimballed platform or payload as discussed in further detail below. The bearing assembly 400 includes a housing 402, a first or outer shaft 404 having an end 406 and an axis 408, corresponding to the gimbal axis for the platform or payload to be stabilized using the bearing assembly 400. The bearing assembly 400 also includes a bearing 410 (also referenced herein as the “outer bearing”). The bearing 410 rotatingly couples the outer shaft 404 to the housing 402 such that the outer shaft 404 is adapted to rotate about the gimbal axis 408 relative to the housing 402.

In the implementation shown in FIG. 4, the bearing 410 includes an inner race member 412 coupled or attached to the outer shaft 404, an outer race member 414 coupled or attached to the housing 402, and a ball or roller bearing 416 disposed between the inner race member 412 and the outer race member 414. In an alternative implementation, the ball or roller bearing 416 may be replaced with another element or material that enables the inner race member 412 and the outer race member 414 to travel relative to each other in the same or opposite directions. For example, the ball or roller bearing 416 may be replaced with a needle bearing or a journal bearing or any combination of roller bearings, ball bearings, needle bearings or journal bearings.

The inner race member 412 is coupled or affixed to the outer shaft 404 such that the inner bearing 410 is rotatingly coupled to the outer shaft 404 as the inner race member 412 travels via the ball or roller bearing 416. In the implementation shown in FIG. 4, the inner race member 412 extends the circumference of the outer shaft 404. Similarly, the outer race member 414 is coupled or affixed to the housing 402 such that the inner bearing 410 is rotatingly coupled to the housing 402 as the outer race member 414 travels via the ball or roller bearing 416.

When the first or outer shaft 404 is rotated or torqued, the bearing 410 imparts a friction disturbance (referenced as 548 in FIG. 5) on this shaft 404. The friction disturbance 548 corresponds to a bearing velocity having a sign corresponding to a direction of shaft 404 rotation. In the implementation shown in FIG. 4, the ball or roller bearing 416 (or its equivalent) may impart the friction disturbance 548 on the inner race member that is affixed to the outer shaft 404 when the outer shaft 404 is initially rotated or torque before the ball or roller bearing 416 starts moving.

The bearing assembly 400 may also include a seal 418 for protecting the outer bearing 410 from contaminants external to the housing 402. The seal 418 may have one end with a sealing lip that rubs on the outer shaft 404 when the shaft 404 is rotated or torqued. In this implementation, seal 418 has another end attached to the housing 402 or the outer race member 414 of the bearing 410. Alternatively, the seal 418 may be reversed so that the seal 418 has an end attached to the outer shaft 404 or the inner race member 412. In this implementation, the sealing lip of the seal 418 may rub on the housing 402. Where reference is made to bearing friction or bearing friction disturbance, the bearing friction or bearing friction disturbance also includes the sealing lip rubbing or friction of the seal.

As shown in FIG. 4, the bearing assembly 400 further includes a second or inner shaft 420 that has a first end 422 and a second end 424. The first end 422 of the inner shaft 420 is adapted to be coupled to a platform or payload (not shown in figures) to be stabilized in accordance with the present invention via the gimbal servo system 500 using the bearing assembly 400. In the implementation shown in FIG. 4, the inner shaft 420 is in coaxial alignment with the outer shaft 404.

In addition, the bearing assembly 400 includes a flex pivot element 426 (also referenced herein as the “inner bearing”) that pivotally couples the end 406 of the first or outer shaft 404 to the second end 424 of the second or inner shaft 420 such that the inner shaft 420 is adapted to rotate relative to the outer shaft 404 via the flex pivot element 426. The flex pivot element 426 is adapted to pivot an angle about the outer shaft or gimbal axis 408 in response to a rotation of the inner shaft 420 due, for example, to a movement of the platform or payload when coupled to the inner shaft 420. The pivot angle (also referenced herein as the “flex pivot displacement”) reflects the angular displacement of the inner shaft 420 relative to the outer shaft 404. The pivot angle corresponds to the friction disturbance 548 imparted by the bearing 410 on the first or outer shaft 404 due to the rotation of the second or inner shaft 420 relative to the housing 402.

The friction disturbance 548 imparted on the first or outer shaft 404 by the outer bearing 410 is effectively eliminated in the gimbal servo system 500 by using the flex pivot element 426 as an inner bearing between the two shafts 404 and 412 as further described herein. The flex pivot element 426 has a predetermined spring rate that may be compensated by the gimbal servo system 500 so that the flex pivot element effectively appears to have no spring rate. The spring rate of the flex pivot element 426 is sufficient to overcome the friction disturbance 548 of the bearing 410. Thus, when a payload or platform having a LOS is attached to the end 422 of the inner shaft 420, the two bearings 410 and 418 enable the gimbal servo system 500 to stabilize the two shafts 404 and 412 (which collectively operate as a gimbal for the payload or platform) while preventing the generation of LOS jitter.

The flex pivot element 426 may be a torsion spring, a flexure bearing, a pivot bearing or other rotational bearing that enables limited angular rotation of the inner shaft 420 relative to the outer shaft 404 with effectively no friction imparted on either shaft 404 or 412. For example, the flex pivot element 426 may be a single end flex bearing (e.g., a model G-30 or H-30) commercially available from C-Flex Bearing Co., Inc. or a cantilevered pivot bearing (e.g., a model 5016-800 or 5020-800) commercially available from the Riverhawk Company. In the implementation shown in FIG. 4, the flex pivot element 426 has a first c-shaped segment 427 attached to the outer shaft 404, a second c-shaped segment 428 attached to the inner shaft 420, and a cross spring member 429 coupling the first c-shaped segment 427 to the second c-shaped segment 428 and adapted to enable the two segments 427 and 428 (and, thus, the two shafts 204 and 420) to be displaced relative to each other without imparting friction on either shaft 404 or 412 in accordance with the present invention.

The bearing assembly 400 may also include a first motor 430 operatively configured to rotate or torque the second or inner shaft 420 about the axis 408 relative to the housing 402. In one implementation, the first motor 430 is a servo or torquer motor having a stator 432 attached to the housing 402 and a rotor 434 attached to the shaft 404 so that the payload attached to the end 422 of the inner shaft 420 may be torqued about the inner shaft 420 by supplying current to the first or torquer motor 430. The inner shaft 420 alone or collectively with the outer shaft 404 corresponds to the gimbal to be stabilized by a gimbal servo system 500.

In the implementation shown in FIG. 4, the bearing assembly 400 includes a position transducer 436 disposed in proximity to the flex pivot element 426. The position transducer 436 is adapted to sense the pivot angle of the flex pivot element 426 and output a corresponding displacement signal 438. The position transducer 436 may be an inductosyn, an RVDT (rotary variable differential transformer), an encoder, a potentiometer, a syncro, a resolver, a ADT (angular displacement transducer), or other device capable of measuring the displacement of the flex pivot element 426.

The first motor 430 is operatively coupled via a servo controller 440 to the displacement signal 438. In this implementation, the servo controller 440 is operatively configured to output a torque compensation signal 442 based on the rotation or angular velocity (e.g., velocity 558 in FIG. 5) of the gimbal or inner shaft 420 (e.g., as sensed and output as signal 444 by a rate sensor 446, such as a gyroscope) and offset by a torque (referenced as the flex pivot compensation torque 541 in FIG. 5) corresponding to the flex pivot displacement signal 438. As part of the gimbal servo system 500, the servo controller 440 is adapted to output the compensation rate signal 442 to the servo or torquer motor 430 to counter the rotation of the inner shaft 420 as reflected by the gimbal velocity signal 444.

In an alternative implementation in which the servo controller 440 is incorporated into the first motor 430, the first motor may be directly coupled to the displacement signal 438 and internally generate the torque compensation signal 442 based on the gimbal angular velocity signal 444 output by the rate sensor 446 and offset by the flex pivot compensation torque 541 derived from the flex pivot displacement signal 438. As further described herein, in either implementation, the first motor 430 is adapted to torque the second or inner shaft 420 relative to the housing 402 in accordance with the torque compensation signal 442 (and, thus, the flex pivot displacement signal 438) to counter the rotation of the inner shaft 420 as reflected by the gimbal velocity signal 444.

Accordingly, the bearing assembly 400 (when used in a gimbal servo system 500 as shown in FIG. 5 for stabilizing the gimbal corresponding to the inner shaft 420 or collectively the shafts 404 and 420) may include the servo controller 440 and the rate sensor 446. The rate sensor 446 may be mounted on the inner shaft 420 upon which the platform or payload is coupled as shown in FIG. 4 or on or in the platform or payload so that the rate sensor 446 is able to sense movement (e.g., angular velocity 558) about the gimballed axis of the platform (e.g., about the gimbal axis 408 corresponding to the coaxially aligned shafts 404 and 420).

In an alternative implementation, the rate sensor 446 may be a tachometer generator, incremental encoder, or other velocity sensor disposed between the shaft 420 and the housing 402. In yet another implementation, the rate sensor 446 may be implemented using a position transducer such as a potentiometer, resolver, encoder, or inductosyn mounted between the shaft 420 and the housing 402.

As shown in FIG. 5, the gimbal servo system 500 may have components similar to the conventional servo system 30. However, by employing the flex pivot element 426 as an inner bearing between the inner and outer shafts 404 and 420, the gimbal servo system 500 is effectively adapted to counter a friction disturbance imparted by the outer bearing 410 on the gimbal or outer shaft 404 based on the flex pivot displacement signal 438 measured and output by the position transducer 436.

For example, in the implementation shown in FIG. 5, the servo controller 440 of the gimbal servo system 500 includes a first summer 532 that is operatively configured to output a velocity difference between a gimbal slew rate command signal 34 (which may be supplied by a vehicle system controller not shown in the figures) and the angular velocity signal 444 output by the rate sensor 446 to reflect the sensed movement (i.e., gimbal velocity 558 in FIG. 5) of the gimballed platform or payload about the gimbal or inner shaft 420. The servo controller 440 also may include a compensator 536, a rate loop gain controller 538, a power amplifier 540, and a second summer 542 disposed between the rate loop gain controller 538 and the power amplifier 540. The compensator 536 is operatively configured to receive the velocity difference output from the summer 532 and output a compensation rate signal 537, which may be adjusted by the rate loop gain controller 538 to have a gain of K_{RL} for output to the second summer 542. In one implementation, the rate loop gain (K_{RL}) for a 25 Hz crossover is 25*2*π, and for a 60 Hz crossover, it is 60*2*π. The summer 542 is operatively configured to output a torque compensation signal 543 as the difference between the compensation rate signal 537 or the gain adjusted compensation rate signal 539 (each of which corresponds to gimbal angular velocity 558 sensed by the rate sensor 446) and the flex pivot compensation torque 541 signal, which is derived via a flex pivot element gain compensator 549 of the servo controller 440 based on the flex pivot displacement signal 438 feedback as output by the position transducer 436. The flex pivot element gain compensator 549 may generate the flex pivot torque as a function of the flex pivot displacement signal 438 and a scale factor or constant compensation gain K_{comp} associated with the spring rate of the flex pivot element 426.

The torque compensation signal 543 may then be amplified by the power amplifier 540, which may output the amplified torque compensation signal 442 to the torquer motor 430. In an alternative implementation, the power amplifier 540 may be incorporated into the first motor 430. In this implementation, servo controller 440 outputs the torque compensation signal 543 to the first motor 430.

The first motor 430 supplies a counter rotation torque 544 based on the torque compensation signal 543 or amplified torque compensation signal 442 (as offset by the flex pivot compensation torque 541) to the gimbal or inner shaft 420. The adjusted or total counter rotation torque 550 acting on the inner shaft 420 (as modeled by the gimbal torquer summer 546) includes the counter rotation torque 544 output by the first motor 430 and a mechanical flex pivot torque 545 generated by the flex pivot element 426 (as modeled by the multiplier 547) based on the spring rate constant (K_{XDCR}) of the flex pivot element 426 and the flex pivot displacement 551.

The adjusted or total counter rotation torque 550, when applied to the gimbal inner shaft 420, is effectively multiplied by the reciprocal of the known gimbal inertia (1/J_{G}) corresponding to the gimbal shaft 420 (as modeled by the multiplier 552). The resulting gimbal acceleration 554 is effectively integrated (as modeled by the integrator 556) to produce the angular velocity 558 (or “gimbal velocity”) of the platform or payload that is sensed by the rate sensor 446. The gimbal or angular velocity 558 is then effectively integrated by the gimbal or shaft 420 (as modeled by the integrator 560) to produce the gimbal or shaft 420 position 462.

The flex pivot displacement 551 corresponds to the difference (as modeled by the summer 564) between the gimbal position 462 (corresponding to the inner shaft 420) and the position 566 of the outer bearing 404 (corresponding to the outer shaft 404).

As shown in FIG. 5, the total torque 568 (as modeled by the summer 570) acting on the outer bearing 410 is the sum of the torque corresponding to the friction disturbance 548 of the bearing 410 (and the seal 418) and the flex pivot torque 545. The total bearing torque 568 is effectively multiplied by the reciprocal of the inertia (1/J_{B}) of the bearing 410 (as modeled by the integrator 572) to produce the acceleration 574 of the bearing 410. The bearing acceleration 574 is effectively integrated (as modeled by the integrator 576) to produce the velocity 578 of the bearing 410. The bearing velocity 578 is effectively integrated (as modeled by the integrator 580) to produce the position 566 of the outer bearing 410. In the implementation of the gimbal servo system 500 shown in FIG. 5, the integrators 572, 576 and 580 are mechanical integrations performed via the interaction of the bearing 410 with the outer shaft 404 and the housing 402 in accordance with the present invention.

As shown in FIG. 5, the bearing friction disturbance 548 imparted on the outer shaft 404 is a function of the bearing velocity 578 and is effectively fed back to the bearing torque summer 570 to combine with the flex pivot torque 545 to define the total bearing torque 568 acting on the outer shaft 404.

Note that if the gimbal slew rate command 34 is zero, the remaining torques acting on the gimbal or shaft 420 (and producing the total counter rotation torque 550) are the flex pivot torque 545 and the flex pivot compensation torque 541 signal used to generate the torque compensation signal 543 via the summer 542. The torque compensation signal 543 is supplied to the amplifier 540 and subsequently to the first motor 430. The output torque 544 of the motor 430 and the flex pivot torque 545 effectively sum to zero or cancel each other. In addition, the flex pivot torque 545 effectively compensates for the bearing friction disturbance 548. Thus, the total counter rotation torque 550 imparted on the gimbal or inner shaft 420 by the gimbal servo system 500 is either effectively zero or corresponds to the gimbal velocity (associated with a gimbal inertia acceleration as modeled by 552) of the platform or payload movement with the bearing friction disturbance 548 effectively compensated by the flex pivot torque 545 such that no LOS jitter is generated.

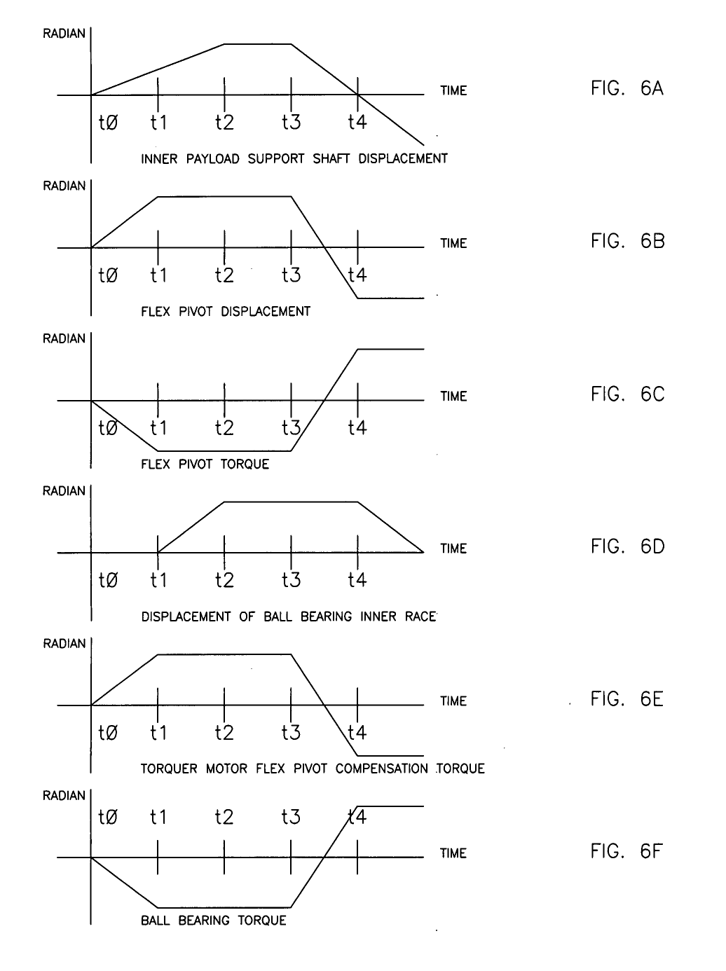

FIGS. 6A-6F illustrate the operation of the bearing assembly 400 as used in the gimbal servo system 500 to stabilize the gimbal or inner payload support shaft 420 in response to a ramp position change of the inner payload support shaft 420. FIG. 6A depicts an exemplary time history graph of the angular position or displacement of the inner payload support shaft 420 of the bearing assembly 400. During a period from time 0 until time t₂, the position or displacement of the inner payload support shaft 420 ramps up reflecting a rotation in one direction. Between time t₂ and t₃, the position of the inner shaft 420 remains constant. Between time t₃ and t₄, the position or displacement of the inner shaft 420 ramps down reflecting a rotation in an opposite direction. FIG. 6B depicts the pivot angle or displacement of the flex pivot element 426 (i.e., the flex pivot displacement 551 as measured by the position transducer 436) based on the angular position 562 or rotation of the inner shaft 420 shown in FIG. 6A. The flex pivot element 426 is initially displaced until t₁ when the flex pivot torque 545 (and flex pivot compensation torque 541) is sufficient enough to overcome the bearing friction disturbance 548 (i.e., total bearing torque out of summer 570 is effectively zero) and move the ball or roller bearing 416 so that the outer shaft 404 rotates. From t₁, until t₂, the flex pivot torque 545 does not change as the ball or roller bearing 416 (and, thus, the outer shaft 404) follows the inner payload support shaft 420 with a constant offset angle corresponding to the flex pivot displacement 551.

FIG. 6C depicts the flex pivot torque 545 generated by the flex pivot element 426 and the flex pivot compensation torque 541 derived via the position transducer 436. The flex pivot torque 545 and the flex pivot compensation torque 541 both correspond to or are proportional to the flex pivot displacement 551 shown in FIG. 6B.

FIG. 6D depicts the displacement of the bearing inner race member 412 (and the outer shaft 404) relative to the bearing outer race member (and the housing 402). As shown in FIG. 6D, until time t₁, the inner race member 412 (and, thus, the outer shaft 404) does not move. At time t₁, when the flex pivot torque 545 as shown in FIG. 6C is sufficient enough to overcome the bearing friction disturbance 548, the displacement of the inner race member 412 (and the outer shaft 404) from the inner payload support shaft 420 increases between t₁ and t₂ in accordance with the inner shaft 420 displacement shown in FIG. 6A.

FIG. 6E depicts the flex pivot compensation torque output 544 generated by the first or torquer motor 430 to torque the inner shaft 420 to counter the torque 545 shown in FIG. 6C of the flex pivot element 426. As previously discussed, the torquer motor 430 is prompted in the gimbal servo system 500 to generate the flex pivot compensation torque output 544 based on the flex pivot compensation torque 541 derived from the flex pivot displacement signal 438 measured by the position transducer 436. In accordance with the present invention, the sum of the flex pivot torque 545 as shown in FIG. 6C and the flex pivot compensation torque output 544 as shown in FIG. 6E is zero.

FIG. 6F depicts the friction disturbance 548 or torque of the bearing 410 imparted on the outer shaft 404. As shown in FIG. 6F, between to and t₁, the friction disturbance 548 or torque of the bearing 410 is imparted on the outer shaft 404 in accordance with the flex pivot displacement 438 of the inner and outer shafts 404 and 420 as shown in FIG. 6B and corresponding flex pivot torque 545 as shown in FIG. 6C. As previously noted, at t₁, the flex pivot torque 545 as shown in FIG. 6C is sufficient enough to overcome the bearing friction disturbance 548. At t₂ the motion of the inner payload support shaft 420 stops as shown in FIG. 6A, which also causes the motion of the inner race member 412 of the bearing 410 to stop as shown in FIG. 6D. At t₃, the inner payload support shaft 420 as shown in FIG. 6A begins moving in the opposite direction. As a result, the flex pivot displacement 438 (as measured by the position transducer 436) shown in FIG. 6B ramps down to the negative of what it had previously been. The flex pivot torque 545 shown in FIG. 6C and its compensating torque 544 from the first or torque motor 430 shown in FIG. 6E also change signs as does the bearing friction disturbance 548 or torque shown in FIG. 6F. At t₄, the bearing 410 and (as a result) the inner race member 412 and outer shaft 404 start to move again as shown in FIG. 6D, in response to the flex pivot torque 545 as shown in FIG. 6C reaching a high enough value that the flex pivot torque 545 can again drive the bearing 410 to move the outer shaft 404.

What has been shown in FIGS. 6A-6F is an ideal friction model where the running and static friction are equal, and the running friction does not vary with position or time. However, the same bearing assembly 400 and gimbal servo system 500 may be successfully employed to compensate for bearing friction disturbance 548 even if the friction 548 of the bearing 410 varies with position. If the bearing 410 friction 548 varies rapidly with time, the amplifier 540 that drives the torquer motor 430 for the payload and the calculation of the input 543 to the amplifier 540 is sufficiently fast so that the flex pivot compensation torque 544 is nearly ideal or equal to the flex pivot torque 545 generated by the flex pivot element 426.

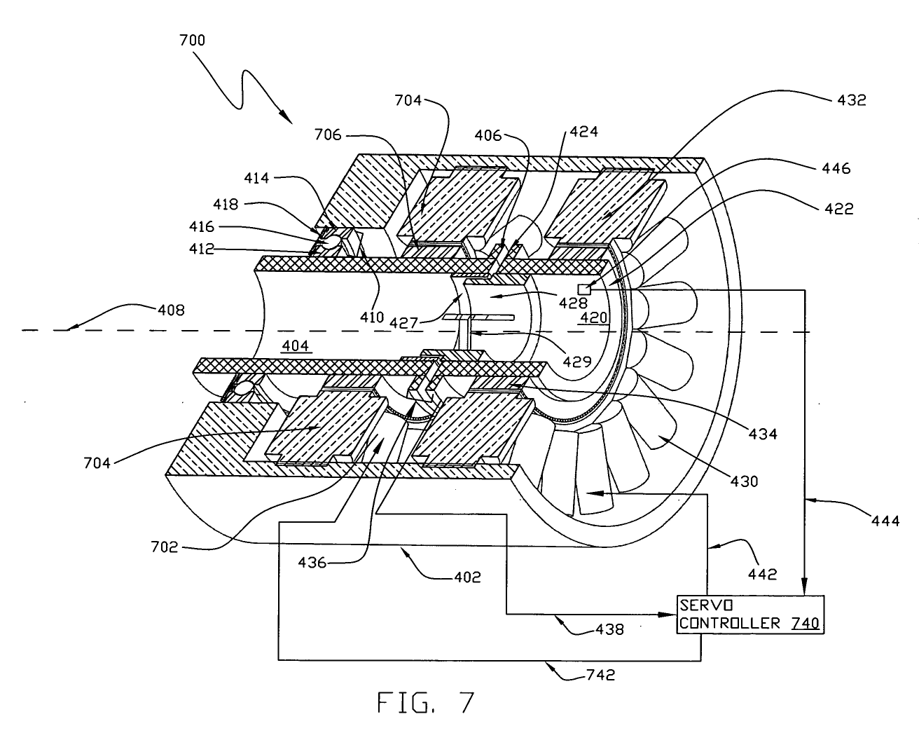

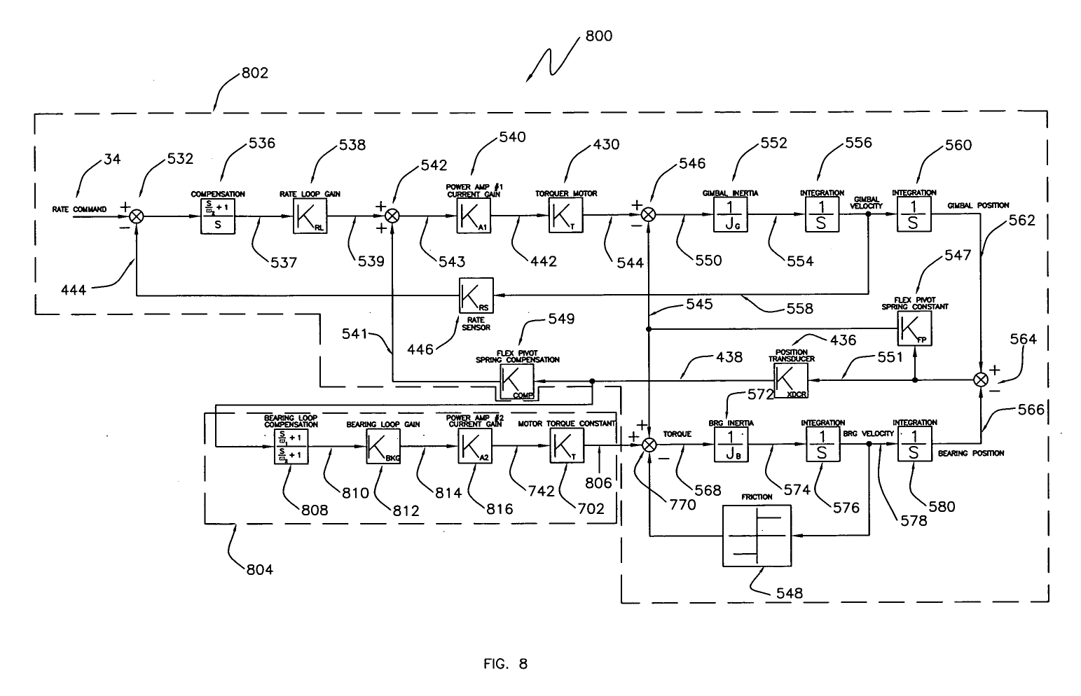

Turning to FIG. 7, a cross-sectional perspective view of another bearing assembly 500 is shown consistent with the present invention. The bearing assembly 700 may be used in a gimbal servo system (such as the gimbal servo system 800 depicted in FIG. 8) to stabilize a gimballed platform or payload as discussed in further detail below. As shown in FIG. 7, the bearing assembly 700 incorporates the bearing assembly 400 and each of its components as discussed above.

The bearing assembly 400 (when operated without the improvements of the bearing assembly 700) may incur a minor step rather than a smooth transition in the movement of the inner race member 412 of the bearing 410 (and the outer shaft 404) when the flex pivot torque 545 generated by the flex pivot element 426 reaches a magnitude where the flex pivot torque 545 exceeds the friction disturbance 548 of the bearing 410.

To alleviate this potential problem, the bearing assembly 700 includes a second motor 702 operatively configured to rotate or torque the first or outer shaft 404 about the axis 408 relative to the housing 402. In one implementation, the second motor 702 is a servo or torquer motor having a stator 704 attached to the housing 402 and a rotor 706 attached to the shaft 404 so that the inner race member 412 of the bearing 410 and the outer shaft 404 may be counter torqued to compensate for the flex pivot torque about the inner shaft 420 by supplying current to the second or torquer motor 702. The second or torquer motor 702 may also be a gear motor or other motor capable driving the inner race member 412 of the bearing 410.

As shown in FIG. 7, the second motor 702 is operatively coupled, via a servo controller 740, to the displacement signal 438 measured by the flex pivot element 426. In one implementation, the servo controller 740 is operatively configured to output, to the second motor 702, a bearing torque compensation signal 742 based on the pivot displacement signal 438. As part of the gimbal servo system 800, the servo controller 740 is adapted to output the bearing compensation rate signal 742 to the servo or torquer motor 430 to counter the flex pivot torque 545 (corresponding to the flex pivot displacement 438) imparted on outer shaft 404 by the flex pivot element 426.

In one implementation, the second or torquer motor 702 torques the bearing inner race member 412 and the outer shaft 404 so that the flex pivot displacement 438 (or angle or deflection) as measured by the position transducer 436 is at or near zero. As a result, when the flex pivot torque 545 generated by the flex pivot element 426 reaches a magnitude where the flex pivot torque 545 exceeds the friction disturbance 548 of the bearing 410, the second motor 702 torques the inner race member 412 of the bearing 410 so that the inner race member 412 (and the outer shaft 404) is prompted to move in a smooth transition or ramp function from a stop position to a rotated position.

As discussed in further detail below, a very small torque due to the flex pivot element 426 may remain on the outer shaft 404, depending on the spring constant of the flex pivot element 426 employed in the bearing assembly 700 and the gimbal servo system 800 using the bearing assembly 700. The torque remaining on the outer shaft 404 is small due to the small displacement 438 of the flex point element 426. It is not necessary that the servo controller 740 or the gimbal servo system 800 (that includes the servo controller) keep the flex pivot angle or displacement 438 or angle to zero so long as the angle or displacement 438 is maintained within the working displacement or angle specified by the flex pivot element manufacturer. Any residual torque generated by the flex pivot element 426 due to the gimbal servo system 800 not keeping the angle or displacement 438 to zero is compensated by a current signal 544 through the first torquer motor 430 as discussed herein.

The servo controller 740 incorporates the servo controller 440 to control (as part of the servo control system 800) the stabilization of the gimbal corresponding to the inner shaft 420 as discussed above. In particular, the servo controller 740 outputs a torque compensation signal 442 based on the rotation or angular velocity (e.g., velocity 558 in FIG. 8) of the gimbal or inner shaft 420 (e.g., as sensed and output as signal 444 by the rate sensor 446) and offset by the flex pivot compensation torque 541 corresponding to the flex pivot displacement signal 438. As part of the gimbal servo system 500, the servo controller 440 is adapted to output the compensation rate signal 442 to the servo or torquer motor 430 to counter the rotation of the inner shaft 420 as reflected by the gimbal velocity signal 444.

Turning to FIG. 8, a functional block diagram of the gimbal servo system 800 is shown that employs the bearing assembly 700. The gimbal servo system 800 includes a gimbal stabilization (or rate) servo loop 802 that corresponds to and operates consistent with the gimbal servo system 500 depicted in FIG. 6. In addition, the gimbal servo system 800 includes a bearing servo loop 804 controlled by the servo controller 740.

With respect to the stabilization servo loop 802, the servo controller 740 of the gimbal servo system 800 includes a first summer 532 that is operatively configured to output a velocity difference between a gimbal slew rate command signal 34 and the angular velocity signal 444 output by the rate sensor 446 to reflect the sensed gimbal movement or velocity 558 of the gimballed platform or payload about the gimbal or inner shaft 420. The servo controller 740 also may include a compensator 536, a rate loop gain controller 538, a power amplifier 540, and a second summer 542 disposed between the rate loop gain controller 538 and the power amplifier 540. The compensator 536 is operatively configured to receive the velocity difference output from the summer 532 and output a compensation rate signal 537, which may be adjusted by the rate loop gain controller 538 to have a gain of K_{RL} for output to the second summer 542. The summer 542 is operatively configured to output a torque compensation signal 543 as the difference between the compensation rate signal 537 or the gain adjusted compensation rate signal 539 (each of which corresponds to gimbal angular velocity 558 sensed by the rate sensor 446) and the flex pivot compensation torque 541 signal, which is derived via a flex pivot element spring gain compensator (modeled by block 549) of the servo controller 740 based on the flex pivot displacement signal 438 feedback as output by the position transducer 436. The flex pivot element gain compensator 549 generates the flex pivot compensation torque 541 signal or command as a function of the flex pivot displacement signal 438 and a scale factor or constant compensation gain K_{comp} associated with the spring rate of the flex pivot element 426. Note the flex pivot displacement signal 438 may be offset or driven to at or near zero (when there is no payload or platform movement sensed by the rate sensor 446) by the gimbal servo loop 804 as further discussed below.

Continuing with the stabilization servo loop 802, the torque compensation signal 543 is amplified by the power amplifier 540, which outputs the amplified torque compensation signal 442 to the torquer motor 430. In an alternative implementation, the power amplifier 540 may be incorporated into the first motor 430. In this implementation, the servo controller 740 outputs the torque compensation signal 543 to the first motor 430.

Consistent with the gimbal servo system 500, the first motor 430 as employed in the stabilization servo loop 802 supplies a counter rotation torque 544 based on the torque compensation signal 543 or amplified torque compensation signal 442 (as offset by the flex pivot compensation torque 541) to the gimbal or inner shaft 420. The adjusted or total counter rotation torque 550 acting on the inner shaft 420 (as modeled by the gimbal torquer summer 546) includes the counter rotation torque 544 output by the first motor 430 and the mechanical flex pivot torque 545 generated by the flex pivot element 426 (as modeled by the multiplier 547) based on the flex pivot element's 426 spring rate constant (K_{XDCR}) and the flex pivot displacement 551.

The adjusted or total counter rotation torque 550, when applied to the gimbal inner shaft 420, is effectively multiplied by the reciprocal of the known gimbal inertia (1/J_{G}) corresponding to the gimbal shaft 420 (as modeled by the multiplier 552). The resulting gimbal acceleration 554 is effectively integrated (as modeled by the integrator 556) to produce the angular velocity 558 (or “gimbal velocity”) of the platform or payload that is sensed by the rate sensor 446. The gimbal or angular velocity 558 is then effectively integrated by the gimbal or shaft 420 (as modeled by the integrator 560) to produce the gimbal or shaft 420 position 462.

Consistent with the gimbal servo system 500, the flex pivot displacement 551 in the gimbal servo system 800 corresponds to the difference (as modeled by the summer 564) between the gimbal position 462 (corresponding to the inner shaft 420) and the position 566 of the outer bearing 404 (corresponding to the outer shaft 404).

As shown in FIG. 8, the total torque 568 (as modeled by the summer 770) acting on the outer shaft 404 is the sum of the torque corresponding to the friction disturbance 548 of the bearing 410 (and the seal 418), the flex pivot torque 545, and the torque 806 (also referenced as “bearing motor torque” or “the flex pivot compensation torque”) output by the second motor 702 as part of the bearing servo loop 804 to counter the flex pivot torque 545 on the outer shaft 404. The total bearing torque 568 is effectively multiplied by the reciprocal of the inertia (1/J_{B}) of the bearing 410 (as modeled by the integrator 572) to produce the acceleration 574 of the bearing 410. The bearing acceleration 574 is effectively integrated (as modeled by the integrator 576) to produce the velocity 578 of the bearing 410. The bearing velocity 578 is effectively integrated (as modeled by the integrator 580) to produce the position 566 of the outer bearing 410. In the implementation of the gimbal servo system 800 shown in FIG. 8, the integrators 572, 576 and 580 are mechanical integrations performed via the interaction of the bearing 410 with the outer shaft 404 and the housing 402 in accordance with the present invention.

The bearing friction disturbance 548 imparted on the outer shaft 404 is a function of the bearing velocity 578 and is effectively fed back to the bearing torque summer 770 to combine with the flex pivot torque 545 and the bearing motor torque 806 to define the total bearing torque 568 acting on the outer shaft 404.

With respect to the bearing servo loop 804, the servo controller 740 of the gimbal servo system 800 includes a lead-lag compensator 808 for stabilizing the frequency response of the bearing servo loop 804. The compensator 536 is operatively configured to receive the flex pivot displacement 438 signal from the position transducer 436 and output a bearing loop or torque compensation signal 810 based on the flex pivot displacement 438. The bearing loop or torque compensation signal 810 generated by the lead-lag compensator 808 brings the frequency response phase of the flex pivot displacement 538 up above a minus 180 degree pole in the vicinity of the zero dB crossover frequency to keep the bearing servo loop 804 stable. The lead-lag compensator 808 employed to keep the loop 804 stable will depend on the friction to inertia ratio and also on the amount of stiction for the bearing 410 (i.e., how much larger the static friction is than the running friction is for the bearing 410). If the stiction is high enough, it may be necessary to add a tachometer generator or some other rate sensor to the bearing servo loop 804 to keep the loop stable.

Continuing with the bearing servo loop 804, the servo controller 740 may also include a bearing loop gain controller 812 and a power amplifier 816. The bearing loop gain controller 812 is operatively configured to adjust the bearing loop or torque compensation signal 810 to have a gain of K_{BRG} for output the adjusted signal 814 to the power amplifier 816.

The adjusted bearing torque compensation signal 814 may then be amplified by the power amplifier 816 to have a current gain of K_{A2} (amps/volt) for output as the amplified bearing torque compensation signal 742 to the second motor 702. In an alternative implementation, the power amplifier 816 may be incorporated into the second motor 702. In this implementation, servo controller 740 outputs the bearing torque compensation signal 814 to the second motor 702.

As previously noted, the second motor 430 supplies a bearing motor torque 806 based on the bearing torque compensation signal 814 or amplified bearing torque compensation signal 742 to the outer shaft 404 to counter the rotation caused by the flex pivot torque 545. As a result, the total torque 568 (as modeled by the summer 770) acting on the outer shaft 404 is the sum of the bearing 410 torque corresponding to the friction disturbance 548, the flex pivot torque 545, and the bearing motor torque 806 maintained by the bearing servo loop 804 to counter the flex pivot torque 545 on the outer shaft 404.

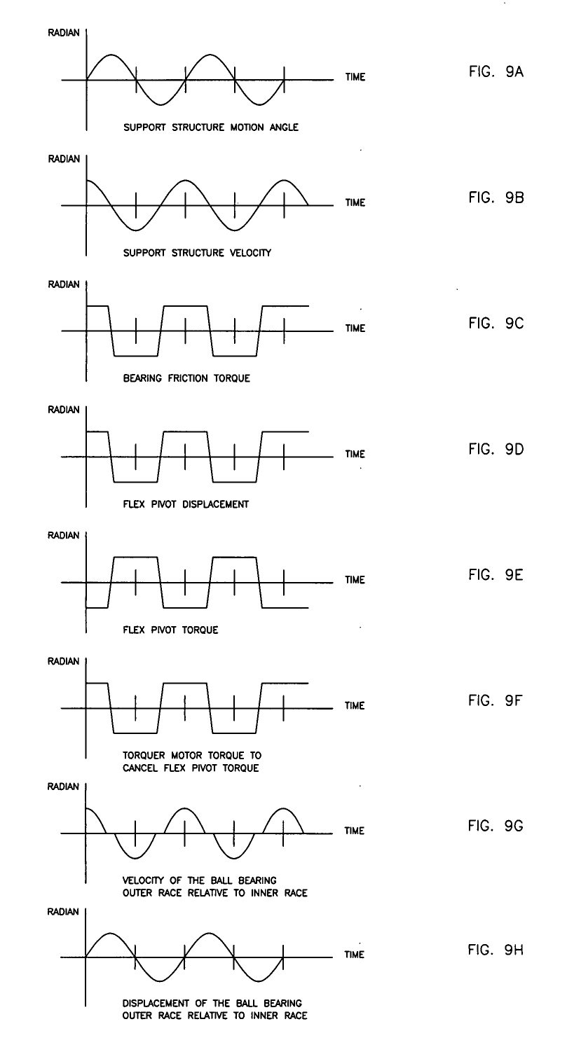

FIGS. 9A-9H illustrate a time history of the operation of the bearing assembly 700 for a sinusoidal motion of the support structure or housing 402. FIG. 9A depicts a sinusoidal position change (i.e., angular position) of the support structure or housing 402 of the bearing assembly 700 relative to the gimbal axis 408 of the outer shaft 404, where the gimbal (i.e., the outer shaft 404) is stabilized or held stationary via the gimbal servo system 800. FIG. 9B depicts the angular velocity of the support structure or housing 402 of the bearing assembly 700 relative to the gimbal axis 408 and the outer shaft 404 in accordance with the integration of the sinusoidal position change shown in FIG. 9A.

FIG. 9C depicts an exemplary friction disturbance or torque 548 of the bearing 410, where the bearing friction disturbance or torque 548 is imparted on the outer shaft 404 in response to the angular velocity or torque of the bearing assembly housing 402 relative to the outer shaft 404 as shown in FIG. 9B. Note that the sign of the bearing friction torque 548 follows the sign of the angular velocity or torque of the housing 402, which may cause LOS jitter of the payload attached to the inner shaft 420 if the bearing friction torque 548 is not compensated, for example, in accordance with the present invention. The bearing friction torque 548 curve shown in FIG. 9C has a finite slope when the velocity of the housing 402 changes sign due to the flexing of the flex pivot. The bearing friction torque curve as shown is ideal friction in that the static friction and running friction are the same in this implementation. However, a gimbal servo system (e.g., 500 or 800) using a bearing assembly (e.g., 400 or 700) implemented in accordance with the present invention is able to compensate for the bearing friction disturbance or torque 548 preventing LOS jitter, even if the static friction of the bearing 410 is greater than the sliding or running friction of the bearing 410.

FIG. 9D depicts the pivot angle or displacement 551 (or pivot angle displacement 438 as measured by the position transducer 436) of the flex pivot element 426, where the pivot angle displacement 551 or 438 is based on the rotation of the inner shaft 420 due to the angular velocity or rotation of the housing 402 as shown in FIG. 9B. As previously noted, the flex pivot element 426 couples the inner shaft 420 to the outer shaft 404 of the bearing assembly 700 and the flex pivot displacement 551 or 438 reflects a displacement of the inner shaft 420 relative to the outer shaft 404.

FIG. 9E depicts the flex pivot torque 545 of the flex pivot element 426 on the outer shaft 404 based on the flex pivot displacement 551 or 438 as shown in FIG. 9D. The flex pivot torque 545 observed in the gimbal servo system 800 is typically considerably less than the bearing friction torque 548 as the second or bearing motor 702 is supplying most of the torque to turn the bearing 410 and, thus, the outer shaft 404.

FIG. 9F depicts the flex pivot compensation torque 544 output by the first or payload torquer motor 430 during operation of the gimbal servo system 800 to torque the inner shaft 420 to counter or cancel the torque 545 of the flex pivot element shown in FIG. 9E, preventing a LOS jitter of the payload from occurring.

FIG. 9G depicts the angular velocity of the bearing outer race member 414 attached to the housing 402 relative to the bearing inner race member 412 that couples the outer shaft 404 to the housing 402. Based on the operation of the gimbal servo system 800 using the bearing assembly 700, the relative bearing 410 velocity, as shown in FIG. 9G, stays at zero as the bearing 410 reverses direction. During the time periods where the bearing 410 reverses direction and the relative bearing velocity is maintained at zero, the flex pivot displacement 551 or 438 and corresponding flex pivot torque 545 are going through zero.

FIG. 9H depicts the displacement of the bearing outer race member 414 relative to the bearing inner race member 412 in response to the angular position change as shown in FIG. 9A of the inner shaft relative to the housing. The tops and bottoms of the peaks of the curve shown in FIG. 9H are slightly flattened reflecting the corresponding periods shown in FIG. 9G where the relative bearing 410 velocity is zero.

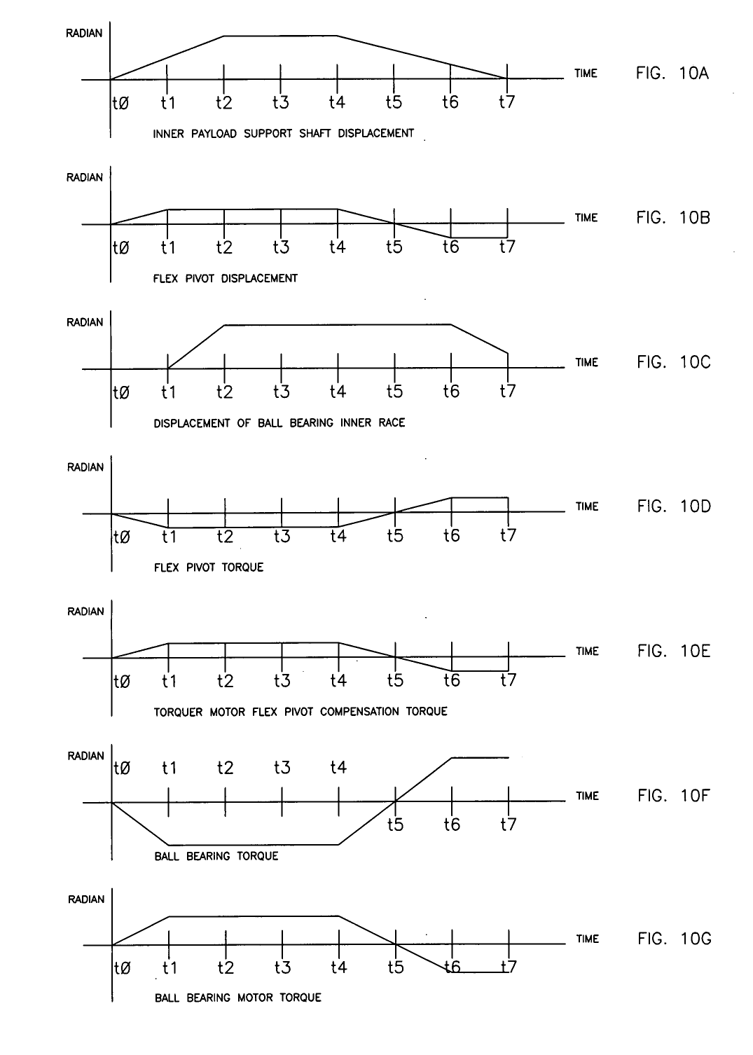

Another exemplary example of the operation of the gimbal servo system 800 employing the bearing assembly 700 is illustrated in FIGS. 10A-10G, in which there is a ramp position change of the inner payload support shaft 420. FIG. 10A depicts an exemplary ramp position change (i.e., angular position) of the inner shaft 420 relative to the housing 402 of the bearing assembly 700. The ramp position change may be, for example, equivalent to a finger turn of the inner shaft 420. During a period from time 0 until time t₂, the position or displacement of the inner payload support shaft 420 ramps up reflecting a rotation in one direction. Between time t₂ and t₄, the position of the inner shaft 420 remains constant. Between time t₄ and t₇, the position or displacement of the inner shaft 420 ramps down (to zero at a time t₇) reflecting a rotation in an opposite direction.

FIG. 10B depicts the pivot angle or displacement 551 or 438 of the flex pivot element 426 of the bearing assembly 700 based on the angular position or rotation of the inner shaft 420 shown in FIG. 10A. The flex pivot element 426 is initially displaced until t₁ when the flex pivot torque 545 (and flex pivot compensation torque 541) is sufficient enough to overcome the bearing friction disturbance 548 (i.e., total bearing torque out of summer 770 is effectively zero) and move the ball or roller bearing 416 so that the outer shaft 404 rotates. As shown in FIG. 10B, the flex pivot element 426 is displaced until t₁ when the gimbal servo system 800 that drives the second or bearing motor 702 has a large enough error signal (e.g., bearing motor torque 806 generated in response to flex pivot displacement 438 input to the bearing servo loop 804 of the gimbal servo system 800 is large enough) to cause the second or bearing motor 702 to overcome the bearing friction disturbance 548 and move the bearing 410. The flex point displacement 438 remains constant from t₁ until t₄, when the direction of motion of the inner payload shaft 420 reverses direction as shown in FIG. 10A.

FIG. 10C illustrates the displacement of the bearing inner race member 412 relative to the bearing outer race member 414 as a result of the flex pivot displacement 551 or 438 shown in FIG. 10B. As shown in FIG. 10C, until time t₁, the inner race member 412 (and, thus, the outer shaft 404) does not move. At time t₁, when the flex pivot displacement 438 shown in FIG. 10B (and corresponding flex pivot torque 545 in FIG. 10D) is sufficient enough to overcome the bearing friction disturbance 548, the displacement of the inner race member 412 (and the outer shaft 404) from the inner payload support shaft 420 increases between t₁ and t₂ in accordance with the inner shaft 420 displacement shown in FIG. 10A. The movement or displacement of the bearing 410 stops at t₂ when the inner payload shaft 420 stops as shown in FIG. 10A. The bearing 410 is displaced or starts moving again in the opposite direction at t₆, when the flex pivot displacement 438 received by the bearing servo loop 804 of the gimbal servo system 800 is sufficient again to overcome the bearing friction disturbance 548. Note that, in accordance with the present invention, the flex pivot displacement 438 shown in FIG. 10B and the displacement of the bearing inner race member 412 shown in FIG. 10C when combined effectively equal the displacement of the inner payload support shaft 420 shown in FIG. 10A.

FIG. 10D depicts the flex pivot torque 545 of the flex pivot element 426 on the outer shaft 404 based on the flex pivot displacement 551 or 438 shown in FIG. 10B. FIG. 10E illustrates the flex pivot compensation torque 544 output by the first or payload torquer motor 430 (based on the flex pivot compensation torque 541 feedback) during operation of the gimbal servo system 800 to torque the inner shaft 420 to counter or cancel the flex pivot torque 545 shown in FIG. 10D. In this implementation, the flex pivot torque 545 and the flex pivot compensation torque 544 are the only torques acting on the inner payload shaft 420. As long as these two torques 545 and 544 are equal and opposite, the torque on the payload shaft 420 is zero.

FIG. 10F depicts the bearing friction disturbance or torque 551 or 438 imparted on the outer shaft 404 in response to the angular position change as shown in FIG. 10A of the inner shaft 420 relative to the housing 402. FIG. 10G illustrates the bearing motor compensation torque 806 output by the second or bearing motor 702 to torque the outer shaft 404 to counter or cancel the bearing friction disturbance or torque 551 or 438 shown in FIG. 10F. In accordance with another aspect of the present invention, the bearing friction disturbance 548 on the outer shaft 404 is overcome by the bearing motor compensation torque 806 output by the second or bearing motor 702 such that the first or payload motor 430 does not have to supply this torque. Thus, in one implementation, the bearing friction disturbance or torque 551 or 438 shown in FIG. 10F is effectively equal to the negative (or opposite sign) of the combination of the flex pivot compensation torque 544 (or 541) shown in FIG. 10E and the bearing motor compensation torque 806 shown in FIG. 10G.

By employing the bearing servo loop 804 and the second or bearing motor 702, the gimbal servo system 800 is able to smoothly move the bearing 410 when the flex pivot displacement 438 is sufficient to overcome the bearing friction disturbance 438 as described herein.

The foregoing description of an implementation of the invention has been presented for purposes of illustration and description. It is not exhaustive and does not limit the invention to the precise form disclosed. Modifications and variations are possible in light of the above teachings or may be acquired from practicing the invention. For example, the components of the described implementation of the servo controller 440 or 740 (e.g., the summers 532 and 542, the compensators 536 and 808, the gain controllers 538 and 812, and the power amplifiers 540 and 816) may be implemented in hardware or a combination of software and hardware. For example, summer 532, the compensator 536, the loop gain controller 538, and the power amplifier 540 may be wholly or partly incorporated into a logic circuit, such as a custom application specific integrated circuit (ASIC) or a programmable logic device such as a PLA or FPGA. Alternatively, the servo controller 440 or 740 may include a central processor (CPU) and memory that hosts component program modules associated with, for example, the compensator 536 and the loop gain controller 538, which are run by the CPU.

Accordingly, while various embodiments of the present invention have been described, it will be apparent to those of skill in the art that many more embodiments and implementations are possible that are within the scope of this invention. Accordingly, the present invention is not to be restricted except in light of the attached claims and their equivalents.

What is claimed is:

1. A bearing assembly suitable for use in a gimbal servo system, comprising:
a housing;
a first shaft having an end and an axis;
a bearing rotatingly coupling the first shaft to the housing such that the first shaft is adapted to rotate about the axis relative to the housing;
a second shaft having a first end and a second end, the first end being adapted to be coupled to a payload; and
a flex pivot element pivotally coupling the end of the first shaft to the second end of the second shaft such that the second shaft is adapted to rotate relative to the first shaft via the flex pivot element;
wherein, in response to a rotation of the second shaft, the flex pivot element is adapted to pivot an angle about the first shaft axis, the pivot angle reflecting a displacement of the second shaft relative to the first shaft.

2. A bearing assembly as set forth in claim 1, wherein the second shaft is in coaxial alignment with the first shaft.

3. A bearing assembly as set forth in claim 1, wherein the pivot angle corresponds to a friction disturbance imparted by the bearing on the first shaft due to the rotation of the second shaft relative to the housing.

4. A bearing assembly as set forth in claim 1, further comprising a first motor operatively configured to rotate the second shaft relative to the housing.

5. A bearing assembly as set forth in claim 4, further comprising a position transducer disposed in proximity to the flex pivot element, the position transducer being adapted to sense the pivot angle and output a corresponding displacement signal, wherein the first motor is operatively coupled to the displacement signal and adapted to torque the second shaft in accordance with the displacement signal.

6. A bearing assembly as set forth in claim 4, further comprising:
a position transducer disposed in proximity to the flex pivot element, the position transducer being adapted to sense the pivot angle and output a corresponding displacement signal; and
a servo controller operatively coupled to the displacement signal and operatively configured to output a torque compensation signal based on the rotation of the second shaft offset by a torque reflected by the displacement signal,
wherein the first motor is operatively coupled to the torque compensation signal and adapted to rotate the second shaft relative to the housing in accordance with the torque compensate signal.

7. A bearing assembly as set forth in claim 6, further comprising a rate sensor adapted to sense an angular velocity of the payload about the axis of the first shaft gimballed axis of the platform and output a corresponding angular velocity signal, wherein the servo controller is operatively coupled to the angular velocity signal and outputs the torque compensation signal based on the angular velocity signal offset by the torque reflected by the displacement signal.

8. A bearing assembly as set forth in claim 6, further comprising a bearing motor operatively coupled to the displacement signal and operatively configured to rotate the first shaft relative to the housing to compensate for the torque reflected by the displacement signal.

9. A bearing assembly as set forth in claim 1, wherein the bearing includes an inner race member attached to the first shaft, an outer race member attached to the housing, and one of a ball bearing or a roller bearing disposed between the inner race member and the outer race member.

10. A bearing assembly suitable for use in a gimbal servo system, comprising:
a housing;
a first shaft having an end and an axis;
a bearing rotatingly coupling to the first shaft to the housing such that the first shaft is adapted to rotate about the axis relative to the housing;
a second shaft having a first end and a second end, the first end being adapted to be coupled to a payload;
a flex pivot element pivotally coupling the end of the first shaft to the second end of the second shaft such that the second shaft is adapted to rotate relative to the first shaft via the flex pivot element; and
wherein, in response to a rotation of the second shaft, the flex pivot element is adapted to pivot an angle about the first shaft axis, the pivot angle reflecting a displacement of the second shaft relative to the first shaft and corresponding to a friction disturbance imparted by the bearing on the first shaft due to the rotation of the second shaft relative to the housing.

11. A bearing assembly as set forth in claim 10, wherein the second shaft is in coaxial alignment with the first shaft.

12. A bearing assembly as set forth in claim 10, further comprising a first motor operatively configured to rotate the second shaft relative to the housing.

13. A bearing assembly as set forth in claim 12, further comprising a position transducer disposed in proximity to the flex pivot element, the position transducer being adapted to sense the pivot angle and output a corresponding displacement signal, wherein the first motor is operatively coupled to the displacement signal and adapted to torque the second shaft in accordance with the displacement signal to counter the friction disturbance of the bearing.

14. A bearing assembly as set forth in claim 13, further comprising a bearing motor operatively coupled to the displacement signal and operatively configured to rotate the first shaft relative to the housing to compensate for the torque reflected by the displacement signal.

15. A bearing assembly as set forth in claim 12, further comprising:
a position transducer disposed in proximity to the flex pivot element, the position transducer being adapted to sense the pivot angle and output a corresponding displacement signal; and
a servo controller operatively coupled to the displacement signal and operatively configured to output a torque compensation signal based on the rotation of the second shaft offset by a torque reflected by the displacement signal,
wherein the first motor is operatively coupled to the torque compensation signal and adapted to rotate the second shaft relative to the housing in accordance with the torque compensate signal.

16. A bearing assembly as set forth in claim 15, further comprising a rate sensor adapted to sense an angular velocity of the payload about the axis of the first shaft gimballed axis of the platform and output a corresponding angular velocity signal, wherein the servo controller is operatively coupled to the angular velocity signal and outputs the torque compensation signal based on the angular velocity signal offset by the torque reflected by the displacement signal.

17. A bearing assembly as set forth in claim 15, wherein the servo controller has a lead-lag compensator operatively configured to output a bearing compensation signal based on the displacement signal, the bearing assembly further comprising a bearing motor operatively coupled to the bearing compensation signal and adapted to rotate the first shaft relative to the housing to compensate for the torque reflected by the bearing compensation signal.
